(19) United States
(12) Patent Application Publication
(10) Pub. No.: US 2017/0238781 A1
(43) Pub. Date: Aug. 24, 2017

(54) DECK TOOL

(71) Applicant: Gerald D. Walsh, Reno, NV (US)

(72) Inventor: Gerald D. Walsh, Reno, NV (US)

(21) Appl. No.: 15/052,769

(22) Filed: Feb. 24, 2016

(51) Int. Cl. A47L 13/08; B08B 1/00

(52) U.S. Cl. CPC A47L 13/08; B08B 1/005

(57) ABSTRACT

A deck tool has a blade edge with unsharpened bumps and an end projection. The blade fits into a gap between planks, where the unsharpened bumps permit sawing of soft gap-clogging material but do not damage structural members. The projection can hook material so that the material may be pulled from the gap or can scrape material from the top of a supporting structure. A handle of the tool may be directly held in hand and may include a feature for attachment of an extension that permits a user to stand upright while using the tool on a plank floor.

### BACKGROUND

Decks and other structures having plank floors often have gaps between the planks. The gaps allow for expansion and contraction of the planks and permit drainage of moisture, which might collect on top of the deck from precipitation or other sources. Dirt and other materials commonly get into and obstruct or clog the gaps between the planks. The clogging material may impede drainage and is particularly a problem over joists or other substructure adjacent to the gaps. Clogging material in a gap over a wood joist may particularly keep the joist wet, which may hasten rotting or other damage. Removing the clogging material may thus extend the useful life of a deck or other structure having a plank floor. The gap-clogging material between planks may also need to be removed before painting, staining, or otherwise treating the planks.

A power washer may be used to direct a high pressure stream of water through the gaps between planks to push the clogging material out of the gaps. Power washers may, however, be unable to remove hard material such as rocks, nails, screws, or pinecone scales that may be tightly wedged in the gap between planks. Power washers may also be less effective where gaps are directly over joists or other structures that block the clogging material from being pushed out of the gaps. Even where power washers are effective at removing material, applying a blast from a high-pressure washer when the nozzle is close enough to remove the clogging material may damage adjacent planks and leave scars or marks that impair appearance of the structure.

### SUMMARY

In accordance with an aspect of the invention, a deck tool includes a blade that is patterned to create a series of unsharpened bumps and an end projection or scraper to hook or scrape material out of a gap between planks. The blade extends from a handle and is thin enough for inserting into a gap between planks of a deck and wide enough to provide sufficient strength to push or pull clogging material out from between the planks. The edge pattern of bumps permits sawing or abrading of soft gap-clogging material, but the bumps may be rounded or blunt so that the sawing or abrading action does not easily damage wood or other structural material. The end projection, which may be implemented as a notch in the blade, may be shaped to hook or catch gap-clogging material so that the clogging material may be removed, e.g., pulled up, from the gap. The end projection may also work as a scraper for scraping or dragging material from the top of a top surface of a joist. The handle may be shaped to be directly held for close manual use and may further include a feature such as treading capable of engaging an extension handle, to permit a user to stand upright while using the tool to clean the gaps between planks.

One specific implementation disclosed herein is a deck cleaning tool. The tool includes a handle, a blade, and a projection hook or scraper. The blade extends from the handle and patterned to include unsharpened bumps along at least one edge of the blade. The projection is at an end of the blade and may be shaped to hook material caught in a gap between planks.

Another specific implementation disclosed herein is a method for removing material from a gap between planks. The method includes: inserting a blade of a tool into the gap; moving the tool up and down while in the gap so that a patterned edge of the blade pulls and pushes material out of the gap; and dragging a projection at an end of the blade along the gap and across a top of a supporting structure under the planks. Dragging the projection can scrape material from the top of the supporting structure.

### BRIEF DESCRIPTION OF THE DRAWINGS

FIG. 1 shows a deck tool in accordance with an implementation having edges with a rounded pattern.

FIG. 2 shows a deck tool in accordance with an implementation having edges with a shallow zigzag pattern.

FIG. 3 shows a deck tool in accordance with an implementation having edges with a shallow plateau pattern.

FIGS. 4A, 4B, and 4C illustrate uses of a deck tool between planks of a deck.

FIG. 5 shows an end view of the handle of a deck tool in accordance with an implementation including a feature for attaching a handle extension.

FIG. 6 shows a user with an upright posture using a deck tool with an extended handle.

The drawings illustrate examples for the purpose of explanation and are not of the invention itself. Use of the same reference symbols in different figures indicates similar or identical items.

### DETAILED DESCRIPTION

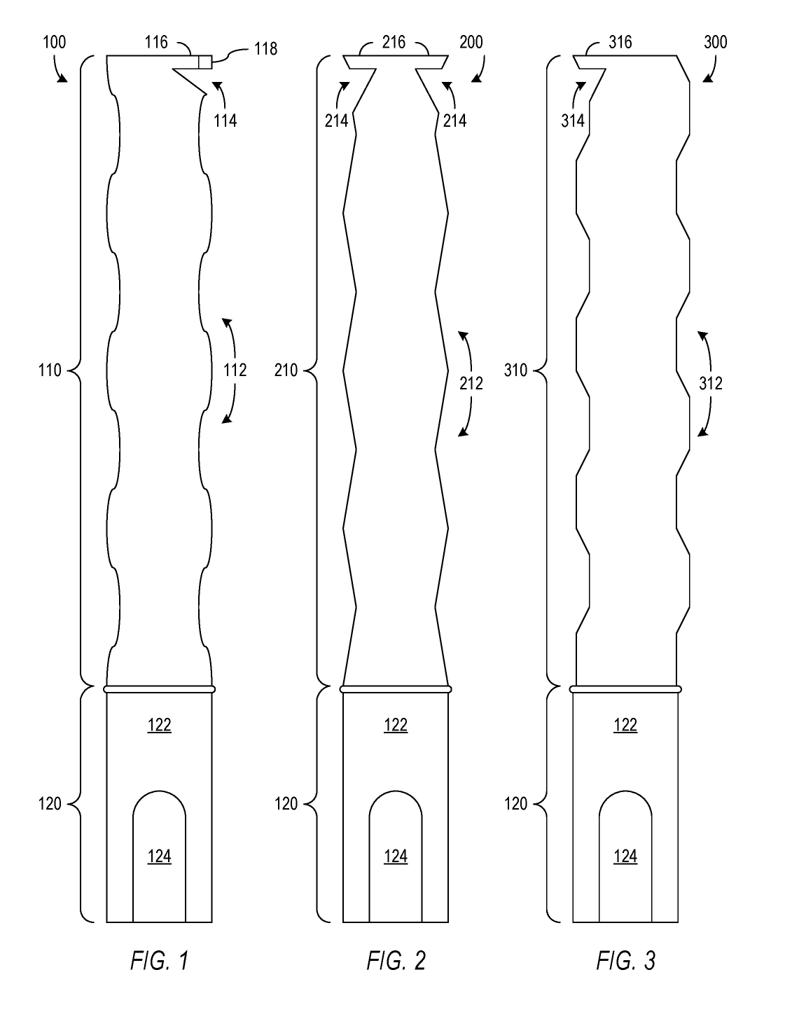

A hand tool may be used to clean material from gaps between planking. FIG. 1 shows a side view of a deck tool 100 having a blade portion 110 and a handle portion 120. Blade and handle portions 110 and 120 may primarily consist of a single core of sheet metal or other material thin enough to fit in a gap between planks, e.g., less than about ¼ inch thick, and of sufficient strength to withstand the mechanical operations described further below. For many applications, the overall length of tool 100 and the core of tool 100 may be between about 10 and 40 inches with blade portion 110 being about 6 to 24 inches long and handle portion 120 being about 4 to 12 inches long. In one specific implementation, the core may be steel or galvanized steel about 1/16 inch thick and between about 1 and 4 inches wide. For example, the core of tool 100 may be made of a tempered or tool grade steel such as employed in handsaws so that blade portion 110 may flex without causing a permanent deformation of tool 100.

Blade portion 110 of tool 100 may have one or both edges patterned to create a series of unsharpened bumps, which may be used for a back-and-forth or up-and-down action as described further below. A unsharpened bumps may be created, as shown in FIG. 1, by having a pattern of rounded peaks and valleys with edges that are blunt or dull. Further, edge 112 may be without any set, i.e., without bending the bumps sideways away from the plane of the major surface of blade 110. In one specific implementation, each bump on edge 112 may be about 1 to 2 inches long, and the depth from peak to valley may be about ¼ to ½ inch. Many other edge patterns could be employed in other implementations to provide dull or unsharpened bumps. FIG. 1 shows blade portion 110 with both edges having the same pattern. Alternatively, the two edges of blade portion 110 may have different patterns, e.g., a smaller or more abrasive pattern on one side.

One or both edges of the blade portion 110 may include a projection 116 that is near an end of blade portion 110. Projection 116 may be formed in blade portion 110 by cutting a notch 114 that is a deeper or more aggressive than pattern 112 so that projection 116 can better hook or catch material. In the implementation of FIG. 1, blade portion 110 has only one projection 116, and a saw-tooth notch 114 creates a projection 116 that extends sideward no further than the peaks in pattern 112. Projection 116 may still be able to hook and drag material that is in a gap between planks. Alternatively, pattern 112 may not include a notch, and instead, projection 116 may extend laterally from blade 110 further than the remainder of pattern 112.

Projection 116 may further include a scraping feature 118, e.g., a tip that may be wider than the thickness of blade portion 110. For example, scraping feature 118 may include a carbide tip or a metal crosspiece that is attached at the end of projection 116. Scraping feature 116 may be blunt but provide a width suitable for scraping or dragging material that may be caught in the gap between planks or on a surface of a joist or other support structure underlying the planks. Alternatively, no scraping feature is added, and the shape and thickness of projection 116 allows for scraping as described herein.

Handle portion 120 may include a covering 122 over a portion of the core of tool 100. Covering 122 may be made, for example, using rubber, tape, plastic, metal, or any material that can that provides a suitable length, thickness, and texture for gripping with one or two hands. In some implementations, the pattern on the edge or edges of blade portion 110 continues to the edge or edges of handle portion 120 and provide a contour for gripping by hand. Handle portion 120 may additionally include an extension attachment feature 124 that facilitates connecting an extension handle to the handle 122 of tool 100. For example, attachment feature 124 may be threaded to receive a threaded broom handle or an extension handle of a type commonly used for painting.

FIG. 2 shows an implementation of a deck tool 200 that includes a blade portion 210 having an edge pattern 212 created with straight line cuts forming a shallow and unsharpened zigzag pattern. For example, edge pattern 212 may have peaks and valleys with angles greater than 120° so that a back-and-forth or sawing movement of edge pattern 212 may abrade or cut into dirt or debris trapped in a gap between planks, but pattern 212 will not significantly cut into wood or other deck material. Cuts to form pattern 212 (and the resulting edges) may be at 90° to the surface of blade portion 210 so that no sharp edges are created. Tool 200 also includes a notches 214 that create two projection 216 on opposite edges of blade portion 210. In tool 200, projections 216 rely on the shape and the thickness of the core material to hook, catch, or scrape debris. Neither projection 216 uses an added tip, but the tip may be shaped or may be at a non-zero angle with the length of blade 210 to better scrape or hook material in a gap between planks. A handle portion 120 of tool 200 may be the same as handle portion 120 of tool 100, which is described above.

FIG. 3 shows an implementation of a deck tool 300 that includes a blade portion 310 having an edge pattern 312 created with straight line cuts forming a series of plateaus. In particular, edge pattern 312 may have flat peaks and flat valleys connected by angled slops so that a back-and-forth or sawing movement of edge pattern 312 may abrade or cut into dirt or debris trapped in a gap between planks, but pattern 312 will not significantly cut into wood or other deck material. Opposite edges 312 of blade portion 310 may be offset so that peaks on one edge 312 are opposite valleys on the other edge 312. The offset pattern may allow for more uniform strength along the length of blade portion 310 and more efficient use of sheet metal from which the core of tool 300 may be cut. Cuts to form patterned edges 312 may be at 90° to the surface of blade portion 310 so that no sharp edges are created. Tool 300 also includes a notch 314 that create a projection 316 on one edge of blade portion 310. A handle portion 120 of tool 300 may be the same as handle portion 120 of tool 100, which is described above.

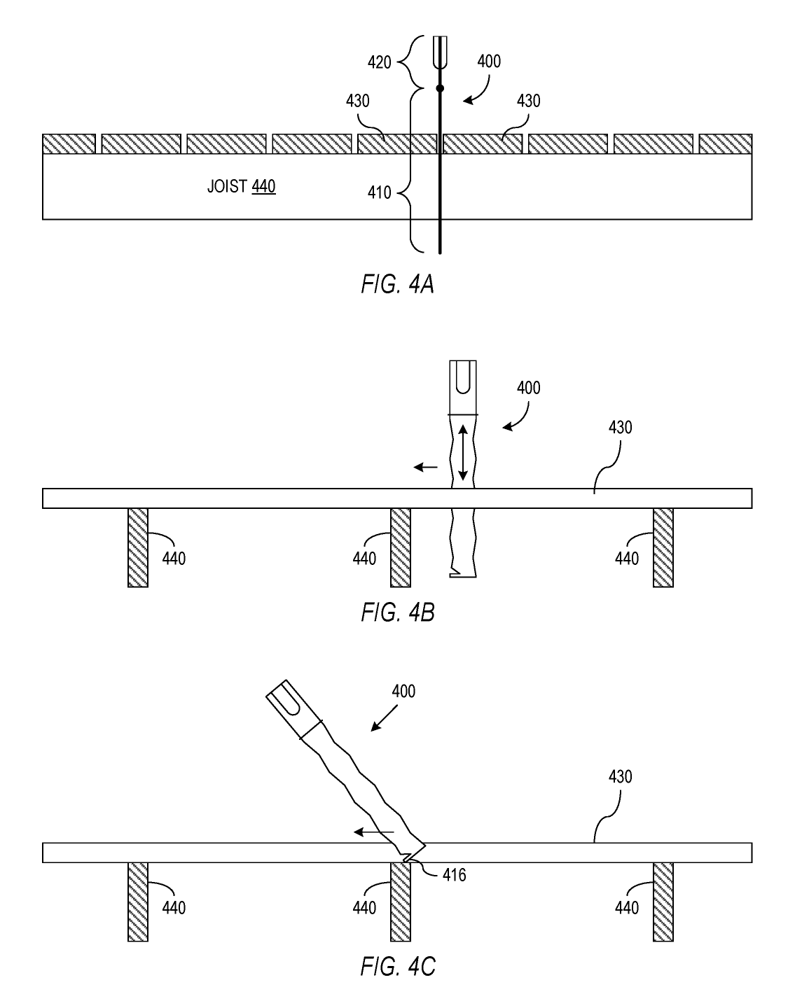

FIG. 4A, 4B, and 4C illustrate a process for using a tool 400 to clean a gap between planks 430 on a support structure including joists 440. Tool 400 may be substantially the same as tool 100 or 200 described above with reference to FIGS. 1 and 2. As shown in FIG. 4A, a blade 410 of tool 400 fits within the gap between planks 430 and extends so that a portion of blade 410 is below plank 430. A user can work tool 400 up and down (with an edge perpendicular or at any angle to the gap) while moving tool 400 along the gap, e.g., from one joist 440 to the next joist 440 as illustrated in FIG. 4B. If both edges of blade 410 are patterned, a user may move in either direction along the gap while working blade up and down and may reverse direction without removing blade 410 from the gap being cleaned. In general, the up-and-down movement of tool 400 will push some debris down out of the gap and pull some debris up out of the gap. Any dislodged debris can then be easily vacuumed or otherwise removed from the top surface of planks 430. In some configurations of tool 400, the edge pattern of tool 400 provides bidirectional sawing so that both upward and downward movement of tool 400 dislodges debris from the gap with nearly equal efficiency. Alternative, an asymmetric pattern on the edge of tool 400, e.g., a saw-tooth pattern, may more efficiently remove debris when moved in one direction, e.g., when pulled up or when pushed down. Whether the pattern is symmetric or asymmetric, the edge of blade 410 may be unsharpened so that when the edge of tool 400 encounters a joist 440 up and down motion does not easily saw into the joist 410.

FIG. 4C illustrates how when tool 400 reaches a joist 440 a projection 416 on the end of blade 410 can be positioned on the top edge or surface of the joist 440 and dragged across the top of the joist 440 to scrape away debris. The scraped debris may be caught on projection 416 and pulled up and out of the gap or pulled past joist 440 and pushed down and out of the gap. The removal of debris can prevent retention of moisture and prevent rotting, which may occur when joists 440 are wood. Projection 416 can be similarly used to hook material that may be too hard to easily removed from the gap by the sawing motion of tool 400 illustrated in FIG. 4B. For example, projection 416 may be slid under a hard object such as a rock, screw, or nail that may have become wedge in a gap, so that a user can hook and pull the object up out of the gap. Removal of iron items such as nails or screws may be important to prevent rust stains on planks 430 or support structure 440.

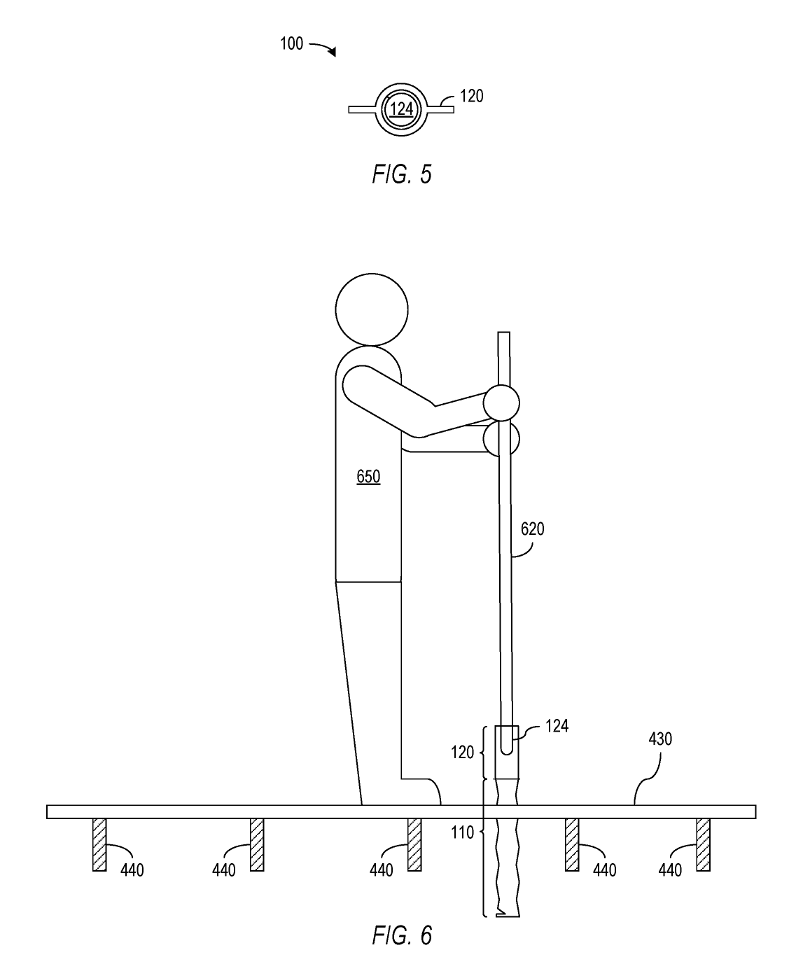

FIG. 5 shows an end view of one implementation of a tool 100 having a handle 120 with an attachment feature 124. Attachment feature 124 includes an openings with threads into which a handle extension 620 may be threaded as shown in FIG. 6. With handle extension 620, a user 650 may stand upright while using a tool to clean the gap between planks 430. Alternatively, a long tool may incorporate an extended handle 620 that is permanently attached to a blade portion 110 that is similar or identical to the blades disclosed above. A detachable handle extension may, however, have the advantage of allowing removal of handle extension 620 when the available working space makes a long handle tool cumbersome. For example, handle extension may be removed when cleaning gaps between planks on stairways or narrow sections of a deck.

Although particular implementations have been disclosed, these implementations are only examples and should not be taken as limitations. Various adaptations and combinations of features of the implementations disclosed are within the scope of the following claims.

What is claimed is:

1. A deck cleaning tool comprising:
a handle;
a blade extending from the handle and patterned to include a plurality of unsharpened bumps along a first edge of the blade; and
a projection at an end of the blade, the projection being shaped to hook material caught in a gap between planks.

2. The tool of claim 1, wherein the bumps comprise rounded undulations.

3. The tool of claim 1, wherein the bumps comprise a series of peaks, each of the peaks forming angle greater than 120°.

4. The tool of claim 1, wherein the bumps comprise a series of plateaus.

5. The tool of claim 1, wherein the handle comprises an attachment feature shaped to engage a handle extension.

6. The tool of claim 1, further comprising a scraper tip that is on the projection, the scraper tip being is wider than the blade.

7. The tool of claim 1, wherein the blade is further patterned to include a plurality of unsharpened bumps along a second edge of the blade.

8. The tool of claim 7, wherein the projection extends sideways on the first edge of the blade, and the tool further comprises a second projection that extends sideways on the second edge of the blade.

9. A method for removing material from a gap between planks, comprising:
inserting a blade of a tool into the gap;
moving the tool up and down while in the gap so that a patterned edge of the blade pulls and pushes material out of the gap; and
dragging a projection at an end of the blade along the gap and across a top of a supporting structure under the planks, wherein dragging the projection scrapes material from the top of the supporting structure.

10. The method of claim 9, further comprising attaching an extension to a handle of the tool, wherein moving the tool comprises a user standing upright and moving the extension.

11. The method of claim 9, further comprising:
placing the projection to hook an object that is caught in the gap; and
moving the blade to remove the object that is hooked on the blade.

12. The method of claim 9, further comprising:
moving the tool in a first direction along the gap while moving the tool up and down so that the patterned edge of the blade pulls and pushes material out of the gap;
reversing direction without removing the tool from the gap, so that the tool moves in a second direction along the gap; and
moving the tool up and down while moving in the second direction so that a second patterned edge of the blade pulls and pushes material out of the gap.
